(19) United States
(12) Patent Application Publication
(10) Pub. No.: US 2008/0184270 A1
(43) Pub. Date: Jul. 31, 2008

(54) METHOD AND APPARATUS FOR SENDING NOTIFICATION TO SUBSCRIBERS OF REQUESTED EVENTS

(75) Inventors: Raymond C. Cole, Powder Springs, GA (US); Shawn M. Constance, Opelika, AL (US); Kyle S. Goodwin, Alpharetta, GA (US); Joshua Bruce Harrison, Norcross, GA (US); William R. Morris, Atlanta, GA (US); John Julius Shilling, Marietta, GA (US)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(73) Assignee: AMERICAN FAMILY LIFE ASSURANCE COMPANY OF COLUMBUS, Columbus, GA (US)

(21) Appl. No.: 11/926,273

(22) Filed: Oct. 29, 2007

Related U.S. Application Data
(60) Provisional application No. 60/863,297, filed on Oct. 27, 2006.

(51) Int. Cl. G06F 9/44

(52) U.S. Cl. 719/318

(57) ABSTRACT

Subscribers are notified of selected incoming events, such as fax or a memo. Subscriber profiles, stored in a database, contain data concerning at least one specified event of which a subscriber wishes to be notified and a procedure by which the subscriber prefers to be notified. When an incoming event occurs (200) data is extracted (205) from the incoming event and the database is queried (210) using the extracted data to identify at least one subscriber whose subscriber profile includes at least one item of the extracted data and the procedure by which the identified subscriber prefers to be notified (215) of the incoming event. An event notification is then prepared (220) for the incoming event in accordance with the determined procedure for the identified subscriber and the event notification is sent (225) to the identified subscriber in accordance with the determined procedure.

### PRIORITY CLAIM

This patent application claims the benefit of U.S. Provisional Patent Application Ser. No. 60/863,297, filed Oct. 27, 2006, the entire disclosure of which is expressly incorporated herein by reference.

### BACKGROUND OF THE INVENTION

1. Field of the Invention

The present invention relates to notifying persons of the occurrence of selected incoming events.

2. Brief Summary of the Invention

Subscribers are notified of selected incoming events, such as fax or a memo. Subscriber profiles, stored in a database, contain data concerning at least one specified event of which a subscriber wishes to be notified and a procedure by which the subscriber prefers to be notified. When an incoming event occurs data is extracted from the incoming event and the database is queried using the extracted data to identify at least one subscriber whose subscriber profile includes at least one item of the extracted data and the procedure by which the identified subscriber prefers to be notified of the incoming event. An event notification is then prepared for the incoming event in accordance with the determined procedure for the identified subscriber and the event notification is sent to the identified subscriber in accordance with the determined procedure. Both a method and an apparatus for the above are disclosed.

### BRIEF DESCRIPTION OF THE SEVERAL VIEWS OF THE DRAWING

FIG. 1 is a block diagram of an exemplary event notification system in an exemplary environment.

FIG. 2 is an exemplary flow chart illustrating the process of the exemplary event notification system.

FIG. 3 is an exemplary flow chart illustrating the process of the subscriber inputting conditions and preferences.

### DETAILED DESCRIPTION OF THE INVENTION

Many businesses have personnel who are mobile and visit customers or prospective customers, or who are often out of the office but still need to know of business events relating to customers and prospective customers. Such mobile personnel may be considered to be “in the field” and, consequently, are sometimes referred to as a “field force.” Such personnel may or may not be in the office on a daily or regular basis, may be in the office on an infrequent or random basis, and/or may be in a lightly-staffed branch office. Such personnel, nonetheless, need or want notice when certain events occur so that they may efficiently and reliably perform their jobs and/or service their customers, follow up with prospective customers, and/or investigate new opportunities. For example, if a memo advises that a customer has not paid the renewal fee for a policy, the field force person responsible for that policy or customer would want to be notified of that memo as soon as possible so that she/he could quickly contact the customer and attempt to convince the customer to renew the policy.

This event notification system allows field force personnel and other interested, authorized personnel (collectively, “subscribers”) to receive real-time notification of events of interest or importance to them. In the event notification system, a subscriber chooses events of interest, and details regarding the events of interest. For example, a subscriber may choose to be notified of all events relating to a particular policy number. As another example, a subscriber may choose to be notified of all events relating to the issuance of a new policy.

Further, the subscriber may want to limit such notices to particular areas of interest. For example, the subscriber may want to be notified of all events relating to the issue of a new policy, but only in a particular part of the country, or a particular state, county, city, country, or territory. These choices, also called “conditions” herein, are stored in a subscriber database.

In addition, there may be company-mandated notification of certain events, such as the need to attend a particular meeting or training course. Such notification may or may not be a “choice” of the person, but may be directed by company policy, procedure, or need. For example, the company may issue a memo advising that a particular office will be closed on a particular date or dates due to a local holiday or office move, due to damage from a storm, flood, or lightning strike, etc. Such an important memo may be directed to some or all personnel so it is preferred that the personnel not have the option of altering the conditions so as not to receive the notification regarding that memo.

In the event notification system, the subscriber can also choose the desired notification method, for example, but not limited to, a telephone call, preferably using voice synthesis, text messaging/short messaging service (SMS), email, and/or a personal web-based company portal. For certain notification methods, for example, a telephone call, the subscriber can also choose the hours within which the notification can be delivered. These notification preferences are also stored in the subscriber database. Thus, subscribers are notified of selected incoming events, such as fax or a memo. The term “memo” is used broadly herein, and generally includes any document intended to notify someone of something, including, but not limited to, a memorandum, a notice, an instruction, an announcement, a request, etc. A memo is typically, but not necessarily, generated internally, that is, it may, but preferably does not, come from outside the company.

In the event notification system, when an incoming event occurs, such as a new memo, at least some fields in the memo are examined to extract certain data. Preferably, the fields to be examined are predetermined. The subscriber database is then queried for the extracted data in the conditions field in the database. This query is preferably done for each item of extracted data so as to provide a list of subscribers who are interested in any particular aspect of the incoming event. As another method, the subscriber database may have an index which indicates which conditions that subscribers have selected. The index is then queried for the extracted data to provide a list of the interested subscribers. As a result of either method, a list is generated of interested subscribers, i.e., those subscribers who wish to be (or must be) notified of the incoming event.

The notification preferences of each subscriber are then examined to determine how the subscriber wishes to be notified. The incoming event, or one or more sections thereof, or a summary thereof, or some information pertaining thereto, or an index or reference thereto, or even some or all of the relevant data therein (collectively “event notification data”) is then sent to the interested subscriber. If a notification preference is by a telephone call then the subscriber preferably can also specify during which hours the call may be placed (or should not placed).

The subscriber's conditions and preferences are stored in a subscriber profile database. If used, the index of conditions may also be stored in the subscriber profile database, or may be stored separately.

Some events may contain confidential data which should not be sent over an insecure communications link. Therefore, preferably, only a limited amount of non-confidential data is sent when there is an event which contains confidential data and the notification method is insecure. Although a company-owned, username and password-protected web site or intranet may be considered to be secure, other methods of communication, such as e-mail, fax, and even voice transmissions, are generally not considered to be secure.

Also, preferably, in addition to the conditions discussed above, the subscriber may also choose certain “negative” conditions, and a subscriber will not be notified of the event if that negative condition exists. For example, the subscriber may want to be notified of all events relating to the issue of a new policy, but not if the policy is to be issued in a particular state, county, city, country, territory, etc. As another example, a subscriber may want to be notified of all events relating to the issue of new policy for a particular product, but not if it includes other products. “Negative conditions” may also include range limitations, whether inclusive or exclusive, such as, but not limited to, a change greater than (less than) 5% with respect to the prior status, etc.

Although the actual implementation is with respect to insurance policies, that is merely an implemented embodiment and is not a limitation. Therefore, although an event may relate to insurance policies, an event is not limited to such and may include other actions, documents, occurrences, etc., of which a person may wish to be notified. Some other types of events, by way of example and not of limitation, are those relating to: service contracts; supply contracts; the use by banking or stock brokerage customers to have notifications of deposits, withdrawals, overdrafts with respect to their accounts, and notifications of opening and closing of those or affiliated accounts; the use by individuals, or companies, relating to their credit reports, such as a sale by a credit bureau of the credit status, including when a creditor or anyone else makes a request for a credit report, creditworthiness, or other information, or when the credit score is changed, whether favorably or unfavorably, the entry of new information or updated information into the credit report; the use by students, relating to their status at schools, colleges and universities, such as to have notification for registration in classes, payment or lack thereof for tuition, books and fees, publication of grades for courses taken, status of their transcript, status or change in requirements for graduation, entry or new or updated information; the use by pensioners, with respect to their pension plans and their pension providers, of the status of their personal and/or corporate retirement plan, changes in investment strategy or holdings, entry of new or updated information, notification of changes in benefits, payments or the lack thereof, notification of contributions or a change in contributions, or a change in the contribution schedule, to the plan, calculation of, or changes to, monthly retirement benefits, changes to the plan or their status; etc. Further, “conditions” should be understood to include any field, data, or term which can be defined and used to determine whether an event notification is appropriate, such as, but not limited to, name, street number, street address, city, county, state, ZIP code, territory, country, telephone number, fax number, area code, e-mail address, e-mail domain name, policy number, contract number, credit report reference number, student identification number, pension plan number, date, time, dollar amount, type of policy, group name or number, individual employee name or number, or other customer information, such as an SIC code, etc.

Consider now an example of operation with respect to a policy or contract. Several subscribers log in and establish or update their respective profiles. For example, subscriber 1 wishes to be notified of all events relating to the state of Georgia; subscriber 2 wishes to be notified of all events relating to area code 404, subscriber 3 wishes to be notified of all events relating to area code 404 and all events relating to policy number 12345; and subscriber 4 wishes to be notified of all events relating to policy number 12345 and all events relating to Colorado.

Now consider that the company releases several memos. Memo A advises that a new policy has been issued in Georgia; memo B advises that policy number 12345 has just been renewed in Georgia; memo C advises that Colorado policy number 13579 has lapsed; and a fax D has been received from telephone number 404-555-1212. Predetermined fields in the various memos will be inspected and the data extracted therefrom. For example, memo A has the data “new policy” in a subject field, “Georgia” in a location field, and “memo” in an event type field; memo B has the data “Georgia” in the location field, policy no. “12345” in a policy number field, and “memo” in the event type field; memo C has the data “Colorado” in the location field, “policy lapse” in the subject field, “13579” in the policy number field, and “memo” in the event type field; and the fax has the data “404-555-1212” in a telephone number field and “fax” in the event type field.

The above fields and names are exemplary and other fields and/or different field names may be used, as desired. For example, there could be different voice and fax telephone number fields; there could be an “originating office” field; the “event type” field could have events other than “memo” or “fax”, etc.

This data from these fields, and any other fields which are present, will then be used to query the subscriber profile to determine interested subscribers. The subscriber profile data would, in this example, indicate as follows:

Location: CO (subscriber 4); GA (subscriber 1);

Policy #: 12345 (subscribers 3 and 4); and

Telephone #: Area Code 404 (subscribers 2 and 3).

Querying the subscriber profile for the relevant data in the conditions field would, in this example, result in the following:

Subscriber 1 will receive notification of memos A and B;

Subscriber 2 will receive notification of fax D;

Subscriber 3 will receive notification of memo B and fax D; and

Subscriber 4 will receive notification of memos B and C.

Thus, the event notification system provides timely and efficient notice of events which are of interest or importance to a subscriber.

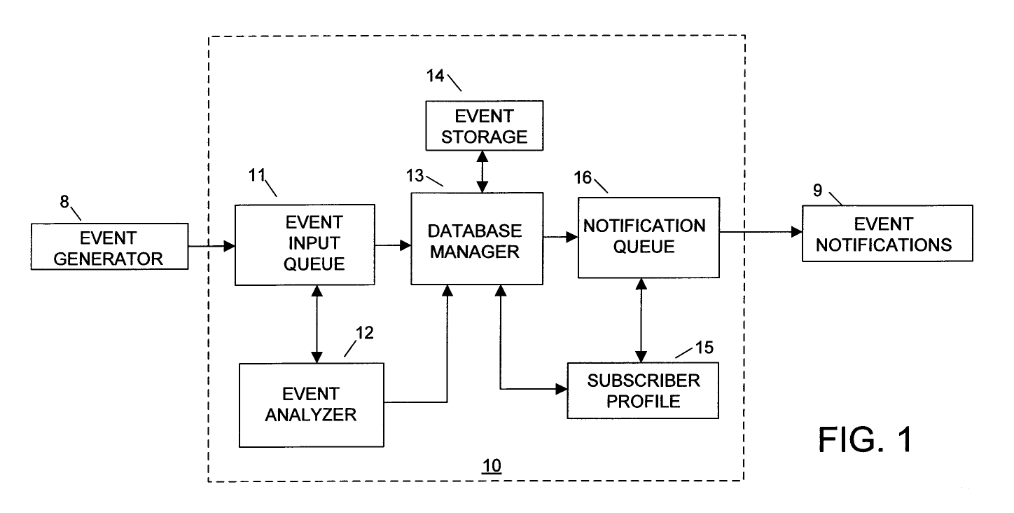

FIG. 1 is a block diagram of an exemplary event notification system 10 in an exemplary environment. An event generator 8 generates events (memo, fax, etc.). The event generator is typically not a single device, but represents several, usually distinct and independent, devices. For example, the event generator will typically comprise at least a fax receiving machine, and a document generator program, such as a word processing, spreadsheet, or presentation program. The fax receiving machine will, upon receiving a fax, forward it to the system 10 for processing and storage. Companies typically generate numerous memos, usually starting in draft form, being revised one or more times, and then finally being released. Once a memo is released, the document generator will forward it to the system 10 for processing and storage or, if the memo is stored, even in unreleased, draft form on the system 10, then the document generator will add a flag, or set a flag, indicating that the document has been released. Determination of when a memo is final, and the decision to release it, is typically done manually. Nonetheless, when the memo is marked final and released, that document is forwarded to the system 10 and/or a flag is set so alert the system that the document is ready to be processed as an event. It should be understood that documents, memos, faxes, emails, etc., with respect to the system 10, are in electronic form.

In the exemplary embodiment shown, the system 10 comprises an event input queue 11. Preferably, all incoming events are placed in this queue and processed sequentially. Once processed, the incoming event is forwarded to the database manager 13 for further action, if appropriate, and for storage. In an alternative embodiment, the queue 11 immediately forwards the incoming event to the database manager 13 for storage and later action. In still another alternative embodiment, the event generator directly provides the incoming event to both the queue 11 and to the database manager 13 for storage and later action. A single memory may serve as both event storage 14 and subscriber profile 15. Alternatively, different memories may be used for each.

When an incoming event occurs, the event analyzer 12 takes action. One action taken by the analyzer 12 is that a flag is added or raised with respect to the incoming event that the analyzer 12 is currently processing. This is a reliability feature. If there is a problem such as a power failure or a system crash, then, when the problem is corrected, the analyzer 12 looks for the flag to determine where to resume processing. This reduces the likelihood that incoming events will be lost. Once the incoming event has been processed by the analyzer 12 then the flag is removed or lowered for that incoming event, and a flag is then added or raised for the next incoming event in the queue 11.

Another action taken by the analyzer 12 is to inspect the incoming event to extract the relevant data therein. In one embodiment, the nature of the incoming event (memo, fax) determines what fields should be inspected. For example, a memo may have a subject field which can be examined to determine whether certain words are present, such as, but not limited to, “memo”, “new policy”, “lapsed”, “lapse pending”. This basic information may be used to identify the form type used for the memo and therefore identify the fields in the memo, the location of each field, and the type of information that is contained in each field. Alternatively, all memos may follow the same format and have the same fields in the same location; different fields will be relevant for different types of memos and therefore some fields may not contain any information. Furthermore, it is contemplated that certain documents, whether internally generated or received from an external source, may be visually inspected by a person who will then enter the appropriate information into one or more of the fields associated with the document.

A fax received incoming event, however, will have little such information. An incoming fax may have, for example, a fax source telephone number provided by the transmitting fax machine, a caller ID telephone number provided by the telephone company, the date and time received, the number of pages, etc. One or more of these fields may not be present, or may not contain any information.

It is also possible, using optical character recognition (OCR) techniques, to inspect incoming events for certain words, phrases, numbers, etc., even if not associated with a field. This may, however, increase the processing time and cause a delay in the event notification. Also, certain words and phrases may appear in many documents, and this may cause unwanted and excessive event notices. This is not to say that OCR could not be used, it is only to say that it is not a preferred embodiment.

In an alternative embodiment, there are multiple event input queues, each event input queue being for a particular type of incoming event. For example, one input queue could be for incoming fax messages, another input queue could be for memos regarding the issuance of new policies, another input queue could be for memos regarding policies which are about to lapse, another input queue could be for memos regarding policies which have just lapsed, another input queue could be for memos regarding pending/prospective policies/business, etc. In this embodiment there would also be multiple event generators, each generating a particular event type, and each providing that particular event to a corresponding event input queue. In this embodiment, there could a single event analyzer, which automatically “knows” the type of input event because of which event input queue it is in; or there could be multiple event analyzers, each analyzer being for at least one, and preferably only one, event input queue. This allows for “parallel” processing of different types of events, which may speed up the delivery of certain types of events, but it may also result in resources which are seriously underused if the corresponding input queue is empty for substantial periods of time.

The analyzer 12, after retrieving the relevant data from the incoming event, sends the relevant data to the database manager 13 as a query of the subscriber profile. Preferably, the database manager 13, the event storage 14, and the subscriber profile 15 are implemented as a relational database. The manager 13 then queries the subscriber profile to determine which subscribers have indicated an interest in the conditions noted. Preferably, but not necessarily, for speed and accuracy, the subscriber profile database has a “conditions” field or an index which is queried. Other techniques may also be used but, regardless of the technique used, the database manager 13 generates a list of interested subscribers.

Preferably, the event analyzer 12 sends a single query containing all of the extracted data terms to the database manager 13. This query may be in alternative form, that is, “term A” OR “term B” OR “term C”, etc., or the database manager 13 may be programmed to execute the query by searching in the alternative format. In either case, the database manager 13 then examines the subscriber profile 15 and returns a list of all subscribers which meet any of the extracted data terms. This provides superior speed and scalability in that only a single query to the database manager is required for each incoming event, even when the number of subscribers increases, and even when the number of extracted data terms increases. This results because a separate query to the database manager 13 for each extracted data term is not required, and because a separate query to the database manager 13 of each subscriber's profile for extracted data terms is not required. It is possible, however, although not preferred, to separately query the database manager for each subscriber's profile in the alternative format, or to separately query the database manager for each extracted data term in all subscribers' profiles.

The database manager 13 then provides this list, and the corresponding event notification data, to the notification queue 16. The notification queue 16 uses the list of interested subscribers to access the subscriber profile 15 to obtain the preferences of the interested subscribers. The notification queue 16 then uses the subscriber preferences to determine what to send to an interested subscriber, how to send it, and, if appropriate, when to send it. The notification queue 16 then sends an appropriate event notification 9 to each interested subscriber. For example, the event notification may to one subscriber may be a voice or fax telephone call which simply states or lists the relevant data obtained by event analyzer 12; whereas the event notification to another subscriber, or for a different document, may be an email message alerting the subscriber to see a particular document number, or may be a message on a company web portal that presents part or all of the relevant document, etc. It will be recalled that, in addition to listing a preferred method of delivery, the subscriber may also list a preferred time or period of time for delivery for certain delivery options, such as by telephone. Thus, the telephone call may be delayed until the preferred time has arrived.

In an alternative embodiment, the event analyzer 12 may obtain the subscriber profile directly from the subscriber profile database 15 and provide all or part of the subscriber profile to the notification queue 16. In still another alternative embodiment, the event analyzer may obtain a reference or pointer to the profile of the interested subscriber and provide that pointer to the notification queue 16. In still another embodiment, the database manager may provide a reference or pointer to the profile of the interested subscriber to the notification queue 16.

In an alternative embodiment, there are multiple notification queues, each notification queue being for a particular notification method. For example, one notification queue could be for fax notification, another notification queue could be voice telephone calls, another notification queue could be for e-mail, another notification queue could be for posting to the person's secure web site page of the company, etc. In this embodiment each notification queue could provide a single event type notification, which automatically “knows” the relevant data which can be sent, and how it should be formatted, because it is designed to handle a specific method of sending the event notification data. This allows for “parallel” processing of different methods, which may speed up the delivery of certain method types, but it may also result in resources which are underused if a notification queue is empty for substantial periods of time.

Once the event notification 9 has been issued, the interested person then reviews the event notification and takes the appropriate or desired action, or non-action, based upon the information therein.

In addition, before an event notification is sent, the event is preferably examined for confidential information. For example, if the document contains a social security number field or a health history field, or some other field which indicates that the information contained therein is or may be confidential, and is therefore information which should not be sent via an insecure link, then this confidential information is removed from an event notification prior to being sent to the subscriber by the insecure link. If the event notification is via a secure link then the confidential information may be removed from the event notification or the information may be allowed to remain therein. This examination and cleaning may be performed by either the database manager 13, the notification queue 16, or the task divided among the two, as desired.

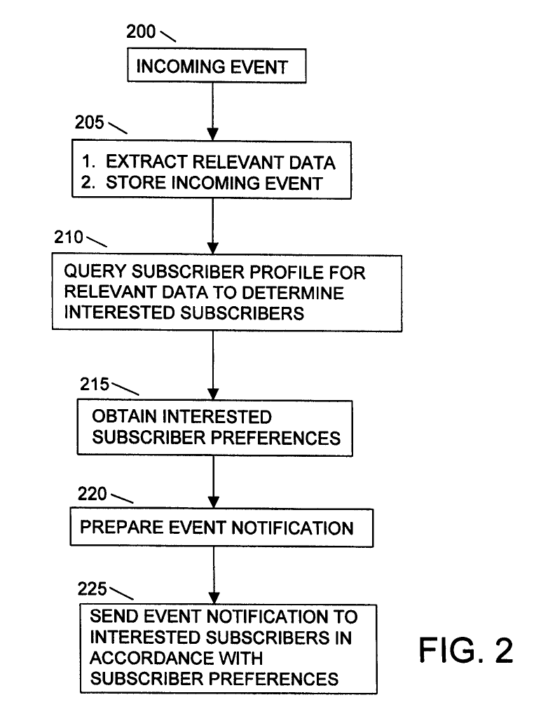

Turn now to FIG. 2 which is an exemplary flow chart illustrating the process of the exemplary event notification system. Upon the occurrence 200 of an incoming event, the relevant data is extracted and, preferably, the event is stored 205. The extracted data from the incoming event is then used to query 210 the subscriber profile database to generate a list of interested subscribers. For the interested subscribers, the subscriber preferences are obtained, or extracted, 215. An event notification is then prepared 220 based upon those subscriber preferences. The event notification is then sent 225 to the interested subscribers in accordance with the preferences of each subscriber.

As previously mentioned, before an event notification is sent, the event is examined for confidential information, which will be removed if the event notification is to be sent via an insecure link.

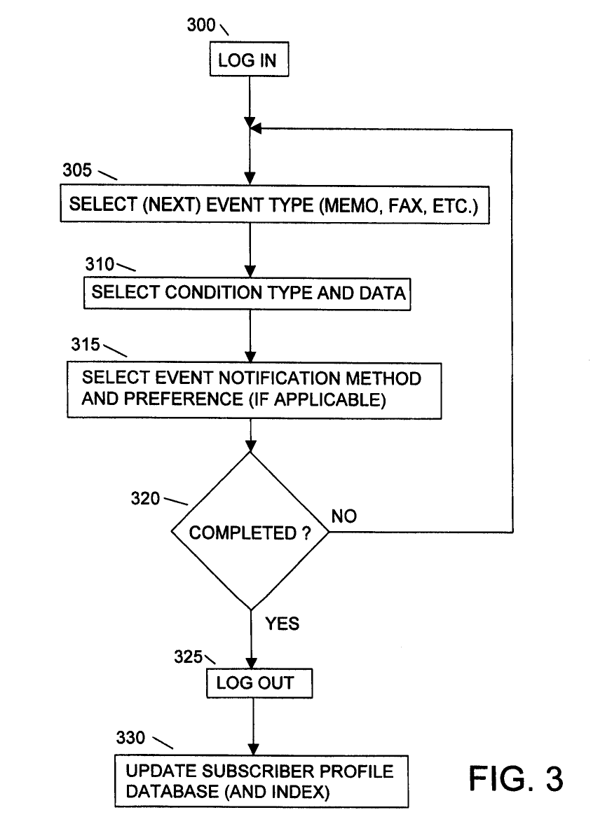

Turn now to FIG. 3 which is an exemplary flow chart illustrating the process of the subscriber inputting conditions and preferences. After logging in 300 the subscriber selects 305 the event type, such as a memo or fax, or any other event type which is supported. The subscriber then selects 310 the desired condition, that is, the condition type and the condition data. The condition type and the condition data which may be selected will depend upon the event type selected. For example, as indicated above, the condition type and the condition data for a fax will generally be different from the condition type and the condition data for a memo, although they may have some fields in common. Also, a “subject” condition type will accept different condition data than a “telephone number” or “fax number” condition type. For example, if the subscriber selects “fax” as the event type, then the subscriber may be presented with the option to select a condition type for a fax, such as a fax source telephone number provided by the transmitting fax machine, a caller ID telephone number provided by the telephone company, the date and time received, the number of pages, etc. The subscriber can then input the desired condition data. For example, if the subscriber selects the “a fax source telephone number provided by the transmitting fax machine” condition type then the subscriber can enter the desired fax source telephone number as the condition data.

The subscriber can then select 315 the desired event notification method, for example, a telephone call, preferably using voice synthesis, text messaging/short messaging service (SMS), email, and/or a personal web-based company portal, etc. The subscriber is then presented with any options appropriate for the selected method. For example, if the selected method is a telephone call, then the subscriber may be allowed to select a range of hours and/or days of the week, calendar dates, etc. during which the telephone call may (or may not) be placed.

The subscriber may enter numerous profile entries, if desired. For example, the subscriber may make one entry for a fax from a first telephone number, make another entry for a fax from a second, different telephone number, make a third entry for a memo having a particular policy number, make a fourth entry for a memo having a particular state, make a fifth entry for a memo having a particular subject, etc. After completion of a profile entry, the subscriber is therefore asked 320 whether the subscriber has completed making profile entries. If not, the subscriber is returned to step 305. If so, then the subscriber logs out 325.

As previously mentioned, the subscriber profile may also have “corporate” entries, that is, entries which are specified by the corporation and over which the subscriber may have limited control or no control. These corporate entries are generally entered in the same manner as subscriber entries but the corporate entry may also designate numerous subscribers at once, rather than having to enter the same information over and over again. In addition, the subscriber may have some control over a corporate entry, such as selecting the method or time of notification, or the subscriber may have no control over any aspect of the corporate entry.

The subscriber profile database 15, and the subscriber index if used, is updated 330 in accordance with the subscriber entries. Although this is shown as occurring after log out, this is merely for ease of illustration to indicate that, at some point, the entries are saved into the subscriber profile database 15. The subscriber profile database 15 could be, and preferably is, updated following completion of each profile entry. The subscriber profile database update procedure is preferably performed by the database manager 13. In an alternative embodiment, the subscriber profile database update procedure is performed by another program or processor or program.

In a preferred embodiment, the notification system 10 is implemented by firmware and/or software on a mainframe database system. However, if the amount of data to be stored is not excessive, then it may be implemented on a PC-based system. It is understood that both the mainframe system and the PC system have one or more processors, volatile and non-volatile memory, power supplies, user input devices (keyboard, mouse, etc.), user output devices (displays, printers, etc.), input and output ports, firmware, software, etc.

Although shown separately in FIG. 1 for clarity of illustration, the event input queue(s) 11, the event analyzer(s) 12, the subscriber profile database 15, and the notification queue(s) 16 are preferably implemented as plug-in software modules for use with the software and/or firmware which operates a relational database manager, such as the database manager 13. This provides for speed and scalability in that, when an incoming event occurs, the data of the incoming event is used to query, such as by SQL (structured query language), the subscriber profile database for matches with selected data. This returns a list of interested subscribers much more quickly and provides for scalability in that the number of subscribers can be significantly increased without significantly slowing down the event notification process or requiring the use of faster computing systems. It is also possible, although not preferred for reasons of speed and scalability, to actually compare the criteria of each subscriber profile to each piece of relevant data contained in the incoming event.

It will be appreciated that some prior art programs, such as Microsoft™ Outlook, provide for forwarding or other actions on e-mail messages. The e-mail message, however, is already specifically directed to the intended party whereas, in the notification system, the incoming event may not be directed to anyone in particular, such as a company memo, or a fax to the company general fax number. Therefore, the notification system is a significant change from, and improvement over, known prior art system.

Some specifics regarding an actual implementation are below.

Event data is drawn from all relevant data environments, generally mainframe-based DB2 (IBM™ Database 2) databases and VSAM (IBM Virtual Storage Access Method) files.

The system could be implemented as a single-tier approach, which is a possible, but not preferred approach, because it could possibly require extensive modifications of underlying software, such as “new-business” processing software, and such as claims entry and processing software, in order to extend the system to a meaningful deployment, that is, a deployment which benefited a large portion of the field force in a timely manner, rather than benefiting only a selected few persons and/or providing delayed notices. Further, such modifications could be difficult and might require a substantial dedicated staff with expertise in the affected areas, such as mainframe applications, and would require extensive approval processes, collaboration, and testing exercises to verify its function and to verify that it did not adversely affect other software functions or speed.

Preferably, a modular design approach is used to ensure portability to new platforms and/or databases, and to provide extensibility to all company data stores. This modular design approach also address the challenge involved retrieving the backend data from the mainframe DB2 and VSAM data stores.

A more agile relationship with the subscribers is obtained by providing real-time information to the subscribers; this reduces call-center polling, raises productivity, and also lowers costs. Additionally, because the event data is preferably centrally stored, then, over time, aggregate events and reports can be easily and efficiently created from this event data.

The event notification systems also allow subscribers to be notified when a certain threshold is exceeded, and reports are generated for such subscribers so that they will be aware of their current performance and trends. This results in a more informed and efficient field force, a less burdened call center, and a more agile method of managing and distributing real-time information.

Preferably, the notification system has three tiers or subsystems: a mainframe tier, a middle tier, and a presentation tier.

The mainframe tier comprises the back-end systems from which events are drawn. In one actual implementation, these systems are primarily DB2 databases and VSAM data stores running on S/390 (z/OS) LPARs (Logical PARtitions) of a mainframe. Other implementations are possible and may be preferable in order to avoid the expense of upgrading the mainframe system unless there is other justification for doing so.

The presentation tier is run on an application server which uses a cross-platform portal, such as the cross-platform portal offered by Plumtree™ Software.

The middle tier preferably provides the framework for event handling, funnels events according to subscriptions, serves the portlets for the presentation tier, and provides access to the various event delivery methods through encapsulated application programming interfaces (APIs). The processing effort of the middle tier is primarily servicing the core APIs. In one implementation, there are three core APIs, each being plug-in based. This design is advantageous in that new delivery methods, data sources, and report types may be added as additional plug-ins without creating the need to re-evaluate and certify the entire application through testing. Preferably, the middle tier is platform agnostic in a general sense so as to provide for widespread utility, but is also preferably easily optimized for a particular platform to enhance speed, reduce processing time, and advantageously use features already available on the platform. With this configuration, the middle tier provides for convenient integration with mainframe-based data stores. For example, in one implementation, a network communication technology, for example, such as IBM's WebSphere™ MQ, is used with the WebSphere Application Server and Java™ Messaging Services. This implementation allows system programming developments which are unconstrained by the overhead of interacting with remote systems which may necessarily be under tight control. Other possible and preferred platforms are an Intel™ NVindowslDB2 platform and the pSeries™ IAIXIDB2 platform.

The back-end API is a queue-based data retrieval layer which interfaces with the existing mainframe DB2 and VSAM data stores. This layer incorporates an intelligent classification strategy to retrieve relevant data from the underlying databases, and pulls the data into a consolidated format.

The eventing API is a push-method data transmittal to the various event delivery APIs which will enable the actual distribution of the events to subscribers. Preferably, at this point the events are already preprocessed, so the recipient event delivery API only needs to pass the data on through the proper medium without any further processing.

The reporting API is preferably a generic layer with an array of specialized plug-ins. Each plug-in will define the characteristics of a particular report type and interact as necessary with the database. The report is then pushed back through the generic layer to the requester through either a static reports mechanism or an application server.

The system may be implemented, for example, using Java2 Platform Enterprise Edition 1 (J2EE1) support for Java Messaging Services (JMS), Enterprise Java Beans (EJB), and WebSphere MQ integration in WebSphere Application Server. These technologies allow scalable, maintainable code which will simplify implementation and integration with existing systems. Database functionality in the form of stored procedures will allow data-bound computations to occur inside the database server rather than clogging the interconnects between the database and application servers with volumes of temporary data. This design therefore provides for the clusterability of database and application servers. The J2EE framework enables smooth, seamless clustering at the application level while maintaining easy access to all the necessary queues, JMS providers, and data objects. Database servers are highly clusterable, so the database-located logic will be able to scale with the data sizes through clustered database servers where necessary. Both the target databases and platforms (pSeries IAIXIDB2 and Intel Windows SQL Server) support such clustering arrangements.

The main subsystems of the middle tier include the database itself, the three major APIs (back-end, eventing, and reporting), the controller, and the Plumtree portlets. Data arrives at the system from the mainframe-based DB2 and VSAM data stores through MQueues which are part the of plug-ins interfacing with the back-end API. This data is processed through Message Driven Beans (MDB), also part of the plug-in, before it is passed on to Entity Beans which are facades for the underlying database representation. Once the data is stored in the database through the Entity Beans, the MDB pass control to the Controller object, which is implemented as a Stateless Session Bean (SSB). The SSB invokes the proper database stored procedures to determine which, if any, subscriptions must be sent notifications in light of the new data, and, if necessary, sends a message through JMS to the Output Queue which serves as the control point for outgoing notifications. The Output Queue is an MDB which can enumerate the various notification delivery methods and invoke the sending method in the one appropriate to the subscription being notified. The notification delivery methods are plug-ins consisting of an SSB interfacing with the appropriate, externally-described notification API.

Augmenting this main flow of data, the two other major subsystems work asynchronously to modify settings, create subscriptions, generate reports, and provide portal visibility. The portlet portion uses a Struts-based servelet and JSP structure to allow for maintainable portlet applications. These portlets interact with the balance of the system through an SSB which may modify the database through the Entity beans when necessary. Portlets are, by nature, pluggable, so there is no specific plug-in interface or API for their implementation. The reporting API will allow asynchronous generation of reports from the database using its capability for data warehousing.

The database schema makes the stored procedures efficient, small, and maintainable. Stored procedures may be generated using, for example, an administrative console web interface when a new event type or other new feature is desired. Use of an administrative console for such changes provides security which ensures the stability of the current set of stored procedures and also reduces the likelihood of schema-inconsistent changes. Each stored procedure will have only one function: to locate all subscriptions of the same type (the subscription type with which the stored procedure is created to work) which satisfy the given parameters. This limited scope will ensure the stored procedures are, and remain, fast and robust to yield the performance and speed necessary in a high-volume event notification system.

An event is preferably composed of an event type and some variable number of parameters. These parameters provide information about the specifics of the event are the mechanisms by which subscriptions filter the events they car about. Event types are templates which specify the set of valid parameters along with defining the subjective meaning and name of the class of events such as “New Business—Policy Just Issued.” This event type would then have a set of valid parameters—for example, policy number, group number, etc., which are defined as parameter templates. These parameter templates define the type of value and the subjective meaning of the value along with its name and position in the event template.

A subscription is a set of choices made by a user which defines the events for which notifications should be generated. Each subscription is preferably limited to a single event type, but may be filtered by any number of conditions on any or all of that event type's parameters. Subscriptions are created through the portlet interface which allows users to easily select and define their filter parameters and determine the type of notification appropriate when the subscription is satisfied by an event.

Event notifications can be generated in a number of ways through the output plug-in module or modules. In one implementation, the notification methods supported are portal notifications, including, but not limited to, Email, VOX (voice synthesis), and SMS. Each notification method has an associated plug-in which defines the proper event notification method and, preferably, may be called by the output queue. Input plug-ins are defined by creating a method of moving the data from its initial position into the plug-in, filtering the data to be suitable for output to the database, and finally invoking the data-access layer methods the database to add the new event to the database. This action triggers the controller to examine the event and causes the stored procedures to evaluate whether any subscriptions are satisfied by the new event.

One aspect of the event notification system which is unique is its approach to controlling the flow of events through the system from the backend data sources by dynamically selecting the applicable events in the controller and then passing these events on through the output plug-ins to the subscriber. The controller handles the dispatching of events by matching incoming events against subscriptions stored in the database. These subscriptions record the person who created the subscription, the event type to which the person subscribed, and the selection criteria the person wishes to use to filter which events that person will receive. Subscriptions are stored in the database in a normalized fashion such that each selection criterion is a discrete entity which can be joined into a query against an event dynamically. These queries are implemented as stored procedures in the database which contain only a single logical SQL query joining all the relevant factors for all subscriptions and returning a list of the subscriptions which should be notified about the incoming message. This single query per event allows the system to process an incredibly high volume of events with minimum database performance requirements. The stored procedures responsible for this matching are executed by the system each time the metadata about a particular event type is changed, when a new event type is created, or when an old event type is deleted. The stored procedures do not need to be manually modified because they are constructed from the event definition (what the event type is, what parameters it has, what its unique identifiers are, etc.). These generated stored procedures are what the controller calls to determine the list of subscribers to notify about the current event.

Two of the several benefits provided by the use of the stored procedures are that human intervention is not needed to create or update the stored procedures when the metadata about events is changed, and the entire stored procedure is logically only a single SQL query rather than a set of iterative steps. This allows the database to optimize the query automatically, just as it would any other standard query, so that the operation may avail itself of standard database performance enhancing features, such as indexes, partitioning, and transparent clustering.

Any process descriptions, steps, or blocks in the flow or data flow diagrams described herein and/or depicted in the attached figures should be understood as potentially representing modules, segments, or portions of code which include one or more executable instructions for implementing specific logical functions or steps in the process. Alternate implementations are included within the scope of the preferred embodiments of the systems and methods described herein in which steps or functions may be deleted, executed out of order from that shown or discussed, executed concurrently, substantially concurrently, or sequentially, or in reverse order, depending on the functionality involved.

Conditional language, such as, among others, “can”, “could”, “might”, or “may”, unless specifically stated otherwise, or otherwise understood within the context as used, is generally intended to convey that certain embodiments optionally could include, while some other embodiments do not include, certain features, elements and/or steps. Thus, such conditional language indicates, in general, that those features, elements and/or step are not required for every implementation or embodiment.

Various valuable aspects, benefits, capabilities, embodiments and/or features have been described above which are not available in the prior art. Further, these various aspects, benefits, capabilities, embodiments and/or features may be used independently or in combination, as appropriate to achieve a desired result; it is not necessary to incorporate every aspect, benefit, capability, embodiment and/or feature into a single implementation in order to obtain specific desired aspects, benefits, capabilities, and/or features.

Other variations of these aspects, benefits, capabilities, embodiments and/or features will suggest themselves to those of skill in the field upon examination of the drawings and detailed description and all such variations are included within the scope of the present invention, as defined by the accompanying claims. Therefore, the scope of the present invention is limited only by the claims below.

We claim:

1. A method for notifying subscribers of the occurrence of incoming events, comprising:
receiving and storing subscriber profiles, a subscriber profile comprising data concerning at least one specified event of which a subscriber wishes to be notified and a procedure by which the subscriber prefers to be notified;
storing the subscriber profiles in a database;
receiving an incoming event;
extracting data from the incoming event;
querying the database for the extracted data to identify at least one subscriber whose subscriber profile comprises at least one item of the extracted data;
determining, from the database, the procedure by which the identified subscriber prefers to be notified;
preparing an event notification for the incoming event in accordance with the determined procedure for the identified subscriber; and
sending the event notification to the identified subscriber in accordance with the determined procedure.

2. The method of claim 1 and further comprising storing the incoming event in an event database.

3. The method of claim 1 wherein the data concerning at least one specified event comprises at least one of a fax or a memo.

4. The method of claim 1 wherein the data concerning at least one specified event comprises a condition, wherein a condition is selected from the group comprising a subject, a location, an event type, a policy number, a telephone number, or an office.

5. The method of claim 1 wherein the procedure by which the subscriber prefers to be notified is selected from the group comprising a telephone call, text messaging, short messaging service, email, or a company portal.

6. The method of claim 1 and further comprising implementing the method using a database server.

7. The method of claim 6 wherein the database server executes a predetermined program and wherein the method is implemented using a plug-in software module executed under the predetermined program.

8. The method of claim 1 wherein querying the database comprises sending all of the extracted data as a single query of the database.

9. The method of claim 1 wherein querying the database comprises sending all of the extracted data as a single query of the database to identify all subscribers whose profile comprises at least one item of the extracted data.

10. The method of claim 9 wherein:
determining the procedure comprises determining, from the database, the procedure by which each identified subscriber prefers to be notified; and
sending the event notification comprises sending an event notification to each identified subscriber in accordance with the determined procedure for each respective identified subscriber.

11. An apparatus for notifying subscribers of the occurrence of specified events, comprising:
a memory to store a subscriber profile database, a subscriber profile comprising data concerning at least one specified event of which a subscriber wishes to be notified and a procedure by which the subscriber prefers to be notified;
an event input queue and analyzer to receive an incoming event and to extract data from the incoming event;
a database manager to receive the extracted data and to query the subscriber profile database to identify at least one subscriber whose subscriber profile comprises at least one item of the extracted data and to determine the procedure by which the identified subscriber prefers to be notified;
a notification queue to prepare an event notification for the incoming event in accordance with the determined procedure for the identified subscriber, and to send the event notification to the identified subscriber in accordance with the determined procedure.

12. The apparatus of claim 11 wherein the memory is also to store the incoming event in an event database.

13. The apparatus of claim 11 wherein the event input queue and analyzer is at least operative to determine whether the incoming event is a fax or a memo.

14. The apparatus of claim 11 wherein the subscriber profile of a subscriber specifies a condition concerning at least one specified event, wherein the condition is selected from the group comprising a subject, a location, an event type, a policy number, a telephone number, or an office.

15. The apparatus of claim 11 wherein the subscriber profile of a subscriber specifies the procedure by which the subscriber prefers to be notified, wherein the procedure is selected from the group comprising a telephone call, text messaging, short messaging service, email, or a company portal.

16. The apparatus of claim 11 wherein the memory contains a predetermined program and at least one plug-in software module, wherein the database manager executes the predetermined program, and wherein the database manager executes the plug-in software module to implement the event input queue and event analyzer.

17. The apparatus of claim 11 wherein the memory contains a predetermined program and at least one plug-in software module, wherein the database manager executes the predetermined program, and wherein the database manager executes the plug-in software module to implement the notification queue.

18. The apparatus of claim 11 wherein the database manager is operative to query the subscriber profile database by sending all of the extracted data as a single query of the subscriber profile database.

19. The apparatus of claim 11 wherein the database manager is operative to query the subscriber profile database by sending all of the extracted data as a single query of the subscriber profile database to identify all subscribers whose subscriber profile comprises at least one item of the extracted data.

20. The apparatus of claim 19 wherein:
the database manager is operative to determine, from the subscriber profile database, the procedure by which each identified subscriber prefers to be notified; and wherein
the event notification queue is operative to send an event notification to each identified subscriber in accordance with the determined procedure for each respective identified subscriber.
